(19) United States
(12) Patent Application Publication
(10) Pub. No.: US 2026/0208549 A1
(43) Pub. Date: Jul. 23, 2026

(54) APPARATUS FOR TRANSPORTING A PAYLOAD

(71) Applicant: JEVONS IP PTY LIMITED, Hamilton (AU)

(72) Inventor: Todd Anthony PEATE, Hamilton (AU)

(21) Appl. No.: 19/141,137

(22) PCT Filed: Dec. 18, 2023
(86) PCT No.: PCT/AU2023/051324

§ 371 Date: Jun. 19, 2025

(30) Foreign Application Priority Data
Dec. 19, 2022 (AU) 2022903892

(51) Int. Cl. B60G 17/0165; B60G 3/20; B60G 17/015; B60G 17/019; B60P 9/00; B62D 7/14; B62D 7/15; F42D 1/10

(52) U.S. Cl. CPC B60G 17/0165; B60G 3/20; B60G 17/0152; B60G 17/019; B60P 9/00; B62D 7/142; B62D 7/1509; F42D 1/10; B60G 2200/10; B60G 2202/413; B60G 2300/02; B60G 2400/60; B60G 2400/821; B60G 2400/823; B60G 2500/30; B60G 2800/019

(57) ABSTRACT

Mobile platform/vehicle 10 to transport explosives/stemming in a hopper 14 over uneven terrain, steep gradients and cross-slopes 11, particularly mining areas. Instrumentation, such as for measuring downhole characteristics of a borehole/drilled hole for receiving explosive/stemming for a blasting operation. The platform/vehicle can be fully autonomous, semi-autonomous or tele-remote operated, and can have independent suspension and/or independent steering for each ground engaging means 16. Leading and trailing ground engaging means can turn/steer together in a similar direction for lateral movement or crabbing. Steering and direction control can be provided by hydraulic or electric drive powering rotation of the ground engaging means about respective upright axes. Height adjustable independent suspension 18 enables respective ground engaging means to follow rising or falling ground level contours and adjust payload support structure 12 height for load levelling during transport over gradients and/or uneven ground. Load cell(s) 38 detect change in payload or payload distribution.

### TECHNICAL FIELD

The present invention relates to apparatus for transporting/delivering a payload, such as a mobile platform or vehicle arranged and configured to traverse contoured terrain having steep gradients, cross-slopes, holes or obstacles, such as at mine sites.

Embodiments of the present invention find application, though not solely, as a mobile platform or vehicle for transporting/delivering explosive and/or stemming to a drill hole/blast hole for blasting in mining operations, such as to aid in the process of blasting to fragment mining benches for the recovery of ore/minerals.

### BACKGROUND

Rock blasting with explosives is often used for fragmenting rock to make ore/minerals embedded in the rock accessible for transport and subsequent processing.

Typically, a blasting plan is developed based on the location of the mine, the prevailing topography, geo-mechanical properties of the rock to be blasted.

Holes are drilled into the rock following completion of the rock blasting plan. Subsequently, explosives and stemming are dispensed into the holes in accordance with the blasting plan. The type and amount of explosive, and any stemming in a drilled hole forms part of the blasting plan. The stemming is any packing or buffering material, such as earth or crushed rock, used to enclose over the explosive charge in the hole. Stemming plays a key role in confining the explosives and making effective utilisation of blasting energy.

ANFO is a commonly used explosive in mine blasting operations. ANFO can be provided as a compound made from ‘prilled’ (pelletised) Ammonium Nitrate (AN) and fuel oil (FO). ANFO is a slurry-like, free flowing explosive; formulated to ensure the appropriate oxygen balance providing optimal energy and sensitivity.

Currently, deposition of explosives and stemming into the drilled holes is often performed manually. The explosives are taken from a safe store and accompanied to the area to be blasted. Operators check the network of drilled holes by manually measuring the hole depth with a tape (aka ‘dipping’), and also check for the presence of any water in the hole by checking the sound emanating from the hole when the distal end of the tape end contacts the bottom of the drilled hole or by inspecting the distal end of the tape after dipping.

The manual process of deposition of explosives and stemming has numerous personal safety risks, such as exposing personnel to manually handling explosives and the associated human error risk of mishandling or coming into direct skin contact with the explosives, or personnel not being at a sufficient safe distance when explosives ignite.

Economic and commercial realities, such as the remote location of mine sites, dictate that there are often difficulties in recruiting and retaining personnel to perform blast hole activities.

When personnel are involved in blasting activities, unstable ground conditions can result in injury or even death due to accidents or misadventure.

Techniques involving semi-automated vehicles configured for deposition of explosives in holes have been considered. However, such techniques are not completely independent of the human factor and may not exhibit acceptable levels of efficiency, quality and predictability of results.

For example, published patent document U.S. Pat. No. 8,950,330 discusses a common type of truck with standard truck chassis and suspension arrangement and configured to load detonation holes with explosives. The truck comprises a tank, a mixing shovel, a feed tube and a control system. The tank is configured to store the explosive material during transportation and loading of the detonation hole, and the feed tube allows the positioning of its free end over the detonation hole, allowing the explosive material to be deposited within the detonation hole after it passes through the feed pipe. The truck shown in U.S. Pat. No. 8,950,330 contains a control for handling the feed tube, arranged inside the vehicle cabin. However, in spite of comprising a feed tube control device, the mentioned device is driven by a human operator, and not automatically, and the standard truck structure is not specifically configured to negotiate unusual or difficult terrain, such as rocky inclines and cross slopes. Also, although the arrangement disclosed in U.S. Pat. No. 8,950,330 allows some distance between the operator and the explosive charge, such distance is absolutely ineffective in an explosion situation. Even if the operator has control of everything while inside the truck cabin, there is a danger of accidental ignition of the explosive charge.

Published patent document WO2010144952 shows an explosive loading truck, provided with a GPS (Global Positioning System), which enables the truck to automatically fill the holes drilled into a bench. In the truck, information such as the geographic positioning of the holes (latitude and longitude), depth and diameter of each hole, and the level of water found in each hole is stored as measured by personnel before delivery of the explosive. This data is sent to the devices in the truck through a wireless communication path. A major problem with the technology disclosed in WO2010144952 is that the truck requires human operation/intervention at various stages of the operation, for example, while inserting the detonator into the hole and during the data input into the truck. Furthermore, the truck is a standard truck chassis and suspension not specifically designed for dispensing explosives on an incline and/or cross slope.

Published patent document CA 2982284 discloses a method or equipment for deposition of explosives to reproduce activities performed by a manual operator in the deposition of explosives that is free from any human intervention. Particularly, CA 2982284 discloses a truck adapted for depositing explosives in holes of open-pit mines automatically and free of human intervention. The truck has GPS and an electronic processor for autonomous travel without any human intervention on the upper surface of a mine bench. The truck is able to direct itself to each of a number of drilled holes. Upon reaching a given hole, the truck is positioned so that the free end of its robotic arm is within reach of the hole to deposit a desired amount of explosive into the hole. However, the truck disclosed in CA 2982284 is a standard type truck not specifically designed for negotiating uneven/abrupt terrain, steep gradients and cross slopes at mine sites.

Published patent document CA 2818188 discloses a mobile vehicle adapted to operate autonomously to approach a drilled hole from which information is to be obtained. An onboard perception system detects the exact location of the hole, and an onboard sensor is deployed from the vehicle into the hole. The perception system has scanners carried on the rear of the vehicle. A downhole sensor unit movable along a swinging arm carries downhole sensors selectively lowerable into the hole by operation of cable reels within the unit. The disclosed vehicle is a standard off-road vehicle adapted with the perception system and swinging arm mounted on the rear and is not specifically designed or configured for negotiating uneven/abrupt terrain, steep gradients and cross slopes at mine sites while safely carrying a payload such as explosives for deposition into the drilled hole.

Thus, it is concluded that both the manual technique of deposition of explosives and the semi-automatic techniques shown in the state of the art have one or more limitations with respect to personal safety.

Previous explosives and stemming vehicles are known to be designed for smooth and level conditions and not suitable for significant gradients (>8%) and uneven surfaces, as the chassis is inadequate to traverse rough terrain and the payload system (often containing hazardous material) is not self-leveling.

A particular problem exists when blasting is conducted on contoured terrain. The delivery vehicle cannot access the blast pattern, and consequently personnel must manually carry the explosive and stemming up/down the gradient/incline in buckets or wheelbarrows. This exposes personnel to hazardous conditions as well as increasing the cost and decreasing productivity of the mining company.

It would therefore be beneficial to provide a mobile platform or vehicle for transport and/or delivery of a payload across terrain of a mine site, such as for delivery of explosive to drilled holes as part of a blasting plan, or to at least provide an alternative to current techniques.

It is to be understood that, if any prior art is referred to herein, such reference does not constitute an admission that the prior art forms a part of the common general knowledge in the art, in Australia or any other country.

### SUMMARY

With the aforementioned in mind, an aspect of the present invention provides an apparatus including a mobile platform/vehicle for transporting and/or delivering a payload across contoured terrain to a drilled hole or blast hole, the mobile platform including a payload support structure, a plurality of ground engaging means for traversing the contoured terrain, and a suspension arrangement supporting the payload support structure on the plurality of ground engaging means.

The suspension arrangement may include height adjustable independent suspension for each ground engaging means that enables the respective ground engaging means to follow rising or falling ground level contours whilst adjusting payload support structure height to maintain an attitude, preferably a level attitude, of the payload substantially level.

At least two of the ground engaging means may be steerable between around +90° and around −90° relative to a forward-rearward 0° axis of the mobile platform. All of the ground engaging means may be steerable between the +90° and −90°, providing around 180° steering and direction control enabling up to 90° direct sideways movement or diagonal crabbing movement of the mobile platform.

The ground engaging means includes a plurality of wheels, such as an even number of wheels e.g. 4, 6, 8, 10, 12 or more.

Each of the ground engaging means or wheels may be independently powered or have dedicated power drive, such as by hydraulic or pneumatic or electric drive, which may be direct or through a gearbox drive.

The suspension arrangement may include at least one actuator providing up-down height adjustment of the payload support structure relative the ground engaging means. The at least one actuator may include at least one hydraulic, pneumatic, or electric actuator, or a combination of any two or more thereof. The at least one actuator may include one or more respective rams (double-acting or single-acting), such as hydraulic or pneumatic rams.

One or more of the actuators may include at least one respective pressure sensor (different to the aforementioned load cells) and/or at least one linear transducer. The at least one respective pressure sensor and/or the at least one linear transducer may be used to detect and/or adjust for change in ground contour(s) as the vehicle/mobile platform traverses the terrain.

The mobile platform/vehicle of the apparatus may include a hydraulic system providing hydraulic pressure and at least one hydraulic pressure sensor, wherein the up-down height adjustment is provided by at least one hydraulic cylinder or ram of the suspension system extending or retracting under control of sensed pressure for the respective hydraulic cylinder or ram associated with a respective ground engaging means to maintain an attitude of the payload support structure.

The mobile platform/vehicle may include at least one sensor system and at least one sensor for sensing at least one of: features of the terrain, geo-fenced boundary, blast/drilled hole location. The at least one sensor system may include one or more of lidar, radar, infra-red, camera, inclination/incline sensor, GPS.

Embodiments may include a control system. The control system may include a control unit. The control system and the at least one sensor system may be configured to identify gradients, inclination of gradients, drop-offs and/or obstacles beyond predefined operating parameters of the mobile platform and prevent the vehicle from progressing into such conditions.

Embodiments of the control system may include controlling feedback from the at least one pressure sensor and/or the at least one linear transducer. For example, embodiments of the control system of the vehicle/mobile platform may sense dips in the terrain and actively drive a respective ground engaging means downward to accommodate for the dip. Likewise, any upward projections of the terrain may be accommodated by the control system actively driving the respective ground engaging means upward to accommodate for the rise in the terrain contour. It will be appreciated that the vehicle/mobile platform may actively maintain a level load and balance load distribution across the ground engaging means.

Pressure sensors may be located in the hydraulic system, such as near the hydraulic actuators. The gyroscope and accelerometer may be located in the control unit. The linear transducers may be respectively located on, in or adjacent the hydraulic actuators.

The at least one sensor may be arranged and configured to transmit signals/data to the control unit which interprets the received signals/data, and wherein the control unit sends control commands back to the hydraulic system.

Embodiments may include the control system configured to predict at least one upcoming gradient, inclination and/or hazard based on current gradient, inclination and/or hazard data and/or past gradient, inclination and/or hazard data.

The control system may provide control of the suspension system and/or steering of the vehicle or mobile platform based on, using or providing feedback to/from the at least one pressure sensor and/or the at least one linear transducer.

The control system may be configured to control the suspension system to actively drive the respective ground engaging means upward to accommodate a rise in the terrain contour.

The control system may be configured to control the suspension system to actively drive the respective ground engaging means downward to accommodate a dip in terrain contour or to control descent of the respective ground engaging means.

The control system may be configured to compare computed and/or calculated gradient, inclination and/or hazard against one or more pre-defined parameters. When the computed/calculated gradient, inclination, and/or hazard data is within the at least one parameter, the control system may instruct the vehicle to proceed. If the computed/calculated gradient, inclination, and/or hazard data outside the at least one parameter, the vehicle/mobile platform the control system may direct the vehicle/mobile platform to take an alternative route or is directed to stop.

Embodiments may include at least one load sensor for sensing a payload supported by the payload support structure. The at least one load sensor may include at least one load cell arranged and configured to sense a payload weight or mass present within the payload container or hopper to assess how much material/payload has been loaded into or unloaded from the container/hopper.

The at least one sensor may include one or more angle sensors, LIDARs, cameras, radar, infra-red, or a combination of any two or more thereof.

Embodiments of the control system may receive data from the at least one sensor at intervals, such as millisecond intervals.

Embodiments of the control system may interpret data into upcoming gradients, inclinations and/or hazards. For example, the control system may predict at least one upcoming gradient, inclination and/or hazard based on current gradient, inclination and/or hazard data and/or past gradient, inclination and/or hazard data.

Embodiments of the control system may be configured to compare computed/calculated gradient, inclination and/or hazard against one or more pre-defined parameters. If the computed/calculated gradient, inclination, and/or hazard data is within the at least one parameter, the control system may instruct the vehicle to proceed. If the computed/calculated gradient, inclination, and/or hazard data outside the at least one parameter, the vehicle/mobile platform is directed by the control system to take an alternative route or is directed to stop, such as for manual retrieval.

The at least one sensor may be mounted on the vehicle/mobile platform. In tele-operational mode, the control system may be located remotely (from the vehicle/mobile platform) and may include human involvement. In autonomous mode, the control system may be located on the vehicle/mobile platform.

Embodiments of the payload support structure may include a container or hopper for holding explosive or stemming. The vehicle/mobile platform may include at least one outlet with an opening, controllably openable-closeable, to underneath the container or hopper for dispensing the explosive or stemming into the drilled/blast hole while the vehicle/mobile platform straddles the drilled/blast hole.

Embodiments of the apparatus may include at least one load sensor for sensing a payload supported by the payload support structure. The at least one load sensor may include at least one load cell arranged and configured to sense a payload weight or mass present within the payload container or hopper. Load sensing through the at least one load cell is used to assess how much material/payload has been loaded into or unloaded from the container/hopper.

The suspension arrangement may provide an up-down articulation range for the payload support structure relative to the ground engaging means of between 1.0 m and 1.5 m, preferably 1.1 m to 1.3 m, and more preferably around 1.2 m, between maximum height up and minimum height down.

The suspension arrangement may include upper and lower suspension links associated with the suspension for at least one of the ground engaging means, preferably for each of the provided ground engaging means. Connection of the ground engaging means to the support structure via a respective upper suspension link arrangement and a respective lower suspension link arrangement can be provided. The upper suspension link arrangement or the lower suspension link arrangement, or both, may include respective upper inner and upper outer suspension arms or links and/or lower inner and lower outer suspension arms or links.

Pairs of the upper and lower suspension link arrangement lower and upper arms or links may be provided for up and down parallel motion of a respective pivot hub/ground engaging means whilst maintaining correct ground engaging means orientation relative to the ground and for steering accuracy.

At least one four-bar linkage type arrangement may be provided as part of the suspension arrangement, such as to enable parallel up-down motion of the respective ground engaging means. Each ground engaging means may be associated with a respective four bar linkage arrangement, thereby providing for up and down movement of the respective ground engaging means. The respective pivot hub may enable rotation of the associate ground engaging means about a vertical axis for steering/direction control of the mobile platform.

The respective pivot hub may include drive means to power rotation of the respective ground engaging means about the respective upright/vertical pivot axis.

Embodiments can include independent suspension on each wheel that enables the wheel/tyre to adjust to rising or dropping ground without the hopper/payload having to tilt. Reference to wheel in this specification includes solid wheels and combinations of solid wheels and resilient tyres/tires, such as rubber compound tyres/tires.

Embodiments can include wheel up-down movement controlled by a hydraulic cylinder that is controlled to respond to changing ground levels. As the ground falls away, or rises, the wheel will drop, or rise, independent of the hopper thus enabling the hopper to stay level ensuring containment of the payload.

### BRIEF DESCRIPTION OF THE FIGURES

One or more embodiments or examples of the present invention will hereinafter be described with reference to the accompanying Figures, in which:

FIGS. 1A to 1C show free space views of a mobile platform or vehicle with load levelling and uneven/steep gradient terrain suspension articulation capability for conveying explosive for blasting at a mine site according to an embodiment of the present invention.

FIGS. 2A to 2C show examples of a mobile platform or vehicle with load levelling and uneven/steep gradient terrain suspension articulation capability according to an embodiment of the present invention.

FIG. 3 shows a cross-section A-A of the mobile platform/vehicle in FIG. 2C according to an embodiment of the present invention.

FIG. 4 shows an embodiment of the present invention relative to a human figure for scale.

FIG. 5 shows a mobile platform/vehicle according to a further embodiment of the present invention.

### DESCRIPTION OF PREFERRED EMBODIMENT(S)

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented.

It will be readily understood that the aspects of the present disclosure, as generally described herein and illustrated in the drawings can be arranged, substituted, combined, separated and designed in a wide variety of different configurations, all of which are contemplated in this disclosure.

Embodiments of an apparatus of the present invention include a mobile platform or vehicle 10 arranged and configured to transport a payload over uneven terrain, steep gradients and cross-slopes 11, particularly in mining areas.

The payload can be or include an explosive, such as ANFO (pilled/pelletized ammonium nitrate (AN) combined with fuel oil (FO)-usually as a slurry) carried in a container, such as a hopper 14.

Alternative or additional payload can include instrumentation, such as for measuring downhole characteristics of a borehole/drilled hole e.g. one or more drilled holes for receiving explosive for a planned blasting operation.

It will be appreciated that the payload support structure 12 can provide a platform or chassis 12 of the mobile platform/vehicle 10, which can be adapted/configured to transport a choice of various payloads as required for a particular operation.

Embodiments of the mobile platform or vehicle 10 can be fully autonomous, semi-autonomous or tele-remote operation.

In tele-remote mode the vehicle or mobile platform may be controlled by an operator (human), such as via line-of-site control or in a remote location. Line of site control may be provided by an umbilical linked controller or wireless controller, such as communicating radio frequency. Control information may be augmented by vehicle/mobile platform speed and/or direction information and may be displayed on the controller. Remote operation/control may be via wireless communication (such as Wi-Fi, dedicated short range communication (DSRC), P2V communication).

Control communication may include at least one image relayed from one or more image capture means, such as one or more cameras, and/or LIDAR devices on the vehicle/mobile platform. Such image information may be augmented by information from one or more other sensors (e.g. sensing speed, acceleration, change of acceleration (jolt or jerk), change of jerk/jolt (snap or jounce) and/or inclination or change of inclination).

In autonomous mode, embodiments of the vehicle/mobile platform may be provided with one or more missions based on a predetermined plan, such as a blast plan. For example, the vehicle/mobile platform may be pre-programmed to travel a particular route and/or pattern (e.g. “proceed to hole #123 and deliver 200 kg into the hole”).

Embodiments may include programmed control instructions, such as ‘return to base if battery is low’ and will proceed to perform those missions automatically.

An operator will still likely be involved when autonomy has encountered a scenario beyond autonomy capabilities and/or as a safeguard. The human operator may input the plan, and/or may confirm that it is OK for the vehicle/mobile platform to proceed (e.g. at a “start mission” point). In autonomous mode, preferably the operator can oversee 3+ vehicles at any one time.

Embodiments of the mobile platform or vehicle 10 can include independent suspension for each ground engaging means and/or independent steering for each ground engaging means. Preferably, a leading pair of ground engaging means and/or a trailing pair of ground engaging means (leading and trailing relative to a forward direction of motion) such as at the respective leading and trailing ends of the mobile platform or vehicle can turn/steer together in a similar direction (e.g. to go left or right). Any ground engaging means between the leading and trailing ground engaging means may have pairs that have ground engaging means which are controlled to turn an amount less than the leading or trailing ground engaging means, or not turn at all, for steering control and positioning control.

Embodiments can include a suspension arrangement 18 (e.g. 18a, 18b, 18c, 18d) configured to support the payload support structure 12 and thus the payload (such as explosive and/or stemming in the hopper 14) on ground engaging means 16 (e.g. 16a, 16b, 16c, 16d). It will be appreciated that the mobile platform or vehicle 10 can have an even number of ground engaging means, such as 4, 6, 8, 10, 12 or more wheels/tyres. Wheels/tyres 16a, 16b, 16c, 16d can include treaded or smooth tyres.

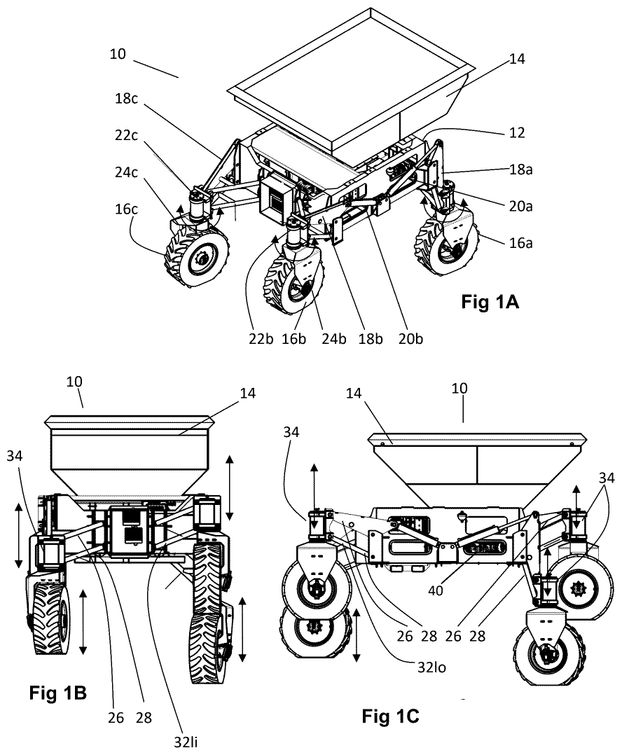

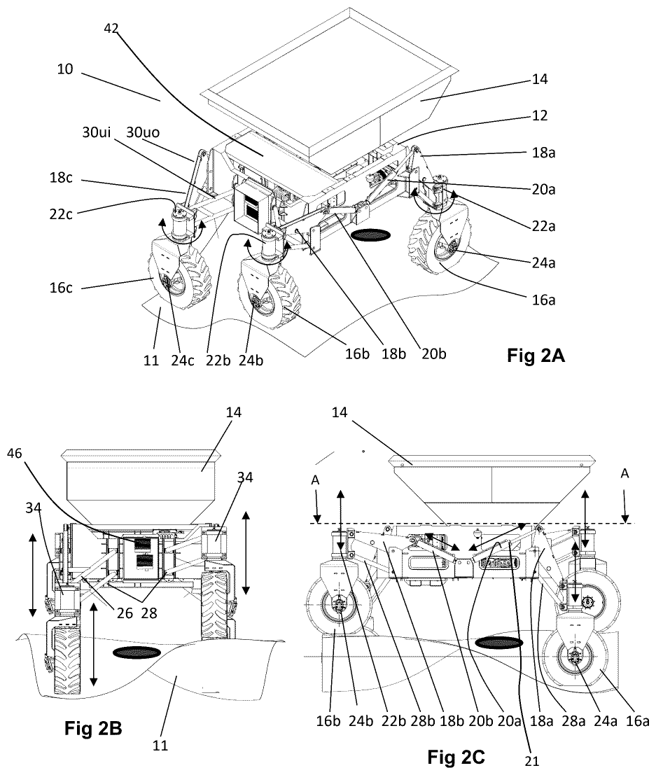

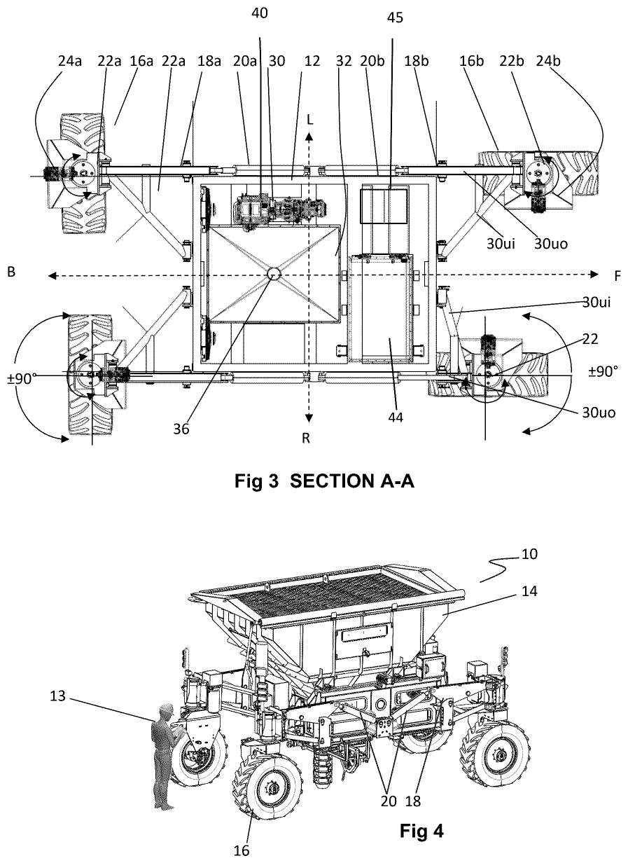

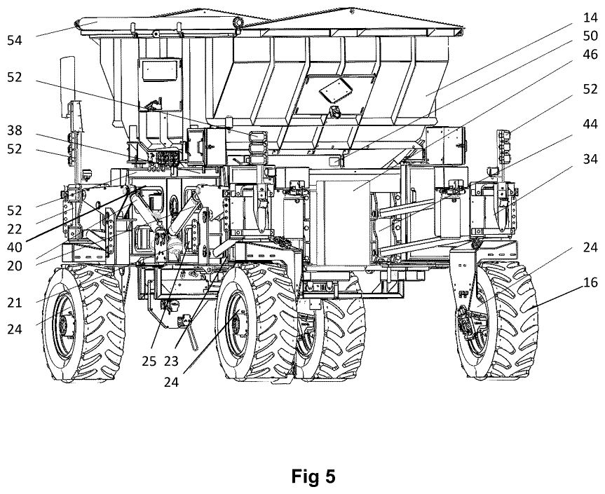

For steering and direction control, some or all of the ground engaging means can be rotated about a respective upright axis associated with the respective ground engaging means-see for example FIGS. 1A and 2A. Steering and direction control can be provided by hydraulic or electric drive to power rotation of the respective ground engaging means about the respective upright axis.

In embodiments, the ground engaging means at the same end of the mobile platform/vehicle (e.g. wheels 16a, 16d and/or 16b, 16c) can be turned in concert to provide steering/direction control. However, it will be appreciated that embodiments include independent control of the ground engaging means for maximum steering and direction control ability. For example, diagonal ‘crabbing’ motion can be imparted for fine positioning or to avoid rocky/uneven terrain.

For suspension and load levelling (such as on gradients and cross-slopes), the suspension arrangement 18 enables movement of the respective ground engaging means relative to the payload support structure (and therefore the payload) and vice versa. For example, on uneven ground 11, the suspension 18a, 18b, 18c, 18d for one or more of the respective ground engaging means can be actively operated/controlled to raise or lower the respective ground engaging means (or reciprocally raise or lower the associated part of the payload support structure/chassis 12 and therefore a portion of the payload to adapt to the uneven ground or to maintain the payload level, or both.

The suspension 18 can be actively driven, such as by at least one actuator 20 (e.g. single acting or double acting rams 20a, 20b, 20c, 20d). A single acting actuator can be driven to extend, with return contraction action provided by gravity/weight acting through the suspension arrangement. Alternatively, a double-acting actuator can be driven to extend and driven to retract, providing quicker action and better overall control compared to the single acting arrangement. The respective actuator(s) can be hydraulic or pneumatic rams or electric actuators.

Embodiments include an onboard power supply, such as batteries and/or hydraulic drive system, which can be provided on the support structure/chassis 12.

Embodiments include both high and low voltage electrical systems. The high voltage system may power movement of the unit e.g. power electric motors or other electric actuators, such as drive motors for the ground engaging means/wheels and/or electric linear actuators or electric motors of the suspension system.

The low voltage system (e.g. 12V-48V) powers, preferably amongst other things, one or more actuators, one or more motors or other electric actuators on the hopper, one or more sensors, one or more lights, a horn and preferably a control unit/processor (e.g. control box 46).

A high voltage battery 44 can serve both the high voltage and the low voltage systems, the latter preferably via a DC/DC converter/transformer.

Embodiments can include a second battery, such as a lead acid battery pack 45, for back-up power to essential systems, such as in the case of failure of the high voltage battery, shut down or removal.

The adaptability of the suspension arrangement and the steering/direction control of the ground engaging means provides for gross and fine movement control of the mobile platform/vehicle 10 across the terrain 11.

Embodiments of the mobile platform/vehicle 10 can include one or more sensors to identify obstacles/hazards. The one or more sensors may include one or more of a gyroscope, accelerometer, thermometer, pressure sensors, LIDAR, camera, radar and infra-red, or a combination of any two or more thereof.

### Embodiments Can Include Any One of, or Any Two or More of:

1. the mobile platform/vehicle (which is responsible for gross and fine movement) across the terrain and houses sensors to identify obstacles/hazards, locate the blast hole;
2. software controlling autonomous and/or tele-remote operations;
3. the payload, such as the container and explosive/stemming and/or instrumentation/sensory equipment having one or more sensors and/or data capture devices.

It will be appreciated that the mobile platform/vehicle need not support a container/hopper for explosive/stemming. The mobile platform/vehicle can support instrumentation/sensory devices for investigating and/or logging terrain or a blast hole map/pattern for future blasting or geo-surveying/downhole surveying.

The payload may be carried in a container, hopper or other suitable reservoir 14, or as an instrument package. A container or hopper 14 containing the explosive or stemming may be dispensed into a drilled/blast hole when informed to do so by a controller onboard the mobile platform/vehicle 46.

By way of example, in use, bulk explosive product (e.g. ANFO) can be loaded into the container (e.g. a hopper or other reservoir 14) from an explosive mobile mixing unit (MMU) or mobile processing unit (MPU) provided near to the area to be blasted or from a bulk explosives depot on or near the mine site. Alternatively, the container can be loaded with stemming material, such as by a truck and mechanical shovel, larger hopper, skid steer loader, forklift etc. Stemming material is used top-off the blast hole to contain the blast of the explosive to maximise fragmentation of the rock. The explosive or stemming can be several tonnes, such as 4-8 tonnes, preferably around 6 tonnes, but can be less or more for a particular application and capacity of the container/hopper.

The mobile platform or vehicle receives instructions from a control system e.g. blast pattern data, GPS data. Preferably the mobile platform/vehicle self-transits to the blast pattern site autonomously. However, tele-remote control may be provided as an alternative or back-up control/guidance arrangement. In the case negotiating significant gradients for contour loading, the mobile platform/vehicle suspension accommodates uneven ground and the steering/direction control can avoid obstructions and provide coarse and fine positioning at or over a blast hole, such as by straddling over the blast hole.

Embodiments include the suspension arrangement providing ground engaging means (e.g. wheel 16) up-down articulation range between 1.0 m and 1.5 m, preferably 1.1 m to 1.3 m, and more preferably around 1.2 m, between maximum height up and minimum height down.

Embodiments include the steering and direction control providing +/−90° steering/direction angle for each ground engaging means (180° total per ground engaging means), such that at full +/−90° the mobile platform/vehicle can transit fully sideways left or right (L, R) at 90° relative to a forward-backward (F-B) direction of travel.

Drilling rigs and the like are commonly propelled on tracks to spread weight. However, such vehicles cannot readily change direction to fine tune positioning when near a hole to be loaded with explosive or to deploy an instrument package down the hole. Tyres/tires are preferred to reduce damage to the ground surface and any blast cord on the ground. Change in direction of the ground engaging means without churning the ground as much as a track/skid-steer system is less likely to break or damage an explosive fuse/blast cord trailing on the ground.

Embodiments of the present invention can include actuator (such as ram/cylinder) pressure regeneration if sufficient pressure is not sensed for a particular ground engaging means, the actuator is preferably able to extend quickly to ensure engagement. This can be accomplished using specific valve arrangement, such as hydraulic valves, and pressure sensing transducers at the actuators (e.g. rams/cylinders 21.

Embodiments include each ground engaging means is powered, such as by a drive means, such as a hydraulic motor, pneumatic motor or electric motor, preferably connected to an output gearbox to provide a required final drive ratio to the respective ground engaging means.

Embodiments including a hydraulic system can include on-board electric power, such as one or more batteries and an electrically driven hydraulic pump arrangement to power the hydraulic system.

Alternatively, or in addition, a plug-in electrical supply can provide the electrical power.

Alternatively, embodiments can include electric drive using electric motors to power the ground engaging means, such as an electric motor, optionally having an output gearbox to modify final drive, for one or more of the ground engaging means (such as electric motor driven wheels).

Likewise, embodiments can include electrically actuated suspension and/or electrically sensed load, travel or pressure on the respective suspension components for use in detecting and/or overcoming obstacles or for decision making in changing direction to avoid tackling the obstacle.

It will be appreciated that load levelling can be provided by suspension articulation. Furthermore, to facilitate detection of obstacles and gradients, embodiments of the mobile platform can include at least one accelerometer gyroscope, linear transducer and/or pressure sensors.

By detecting or measuring pressure at or to/from one or more of the suspension actuators (double or single acting), regeneration can be used to help stabilize the mobile platform/vehicle should it drive over a drilled/blast hole. In such instances, the suspension can be operated to level the load and/or extend a ground engaging means to engage with the ground surfaced within the hole within the limits of the travel of the suspension system.

The pressure sensors can be located in the hydraulic system near the cylinders 21. The gyroscope and accelerometer can be located in the control unit/control box 46. The linear transducers can be located in the hydraulic actuators (e.g. rams/cylinders) 20a, 20b. Sensors transmit data to the control unit/control box which interprets the data and send commands back to the hydraulic system.

It will be appreciated that having 6 or more spaced ground engaging means can provide greater stability should one ground engaging means be suspended over a hole. Embodiments having ground engaging means at four positions (front left, front right, rear left, rear right) may be provided with greater suspension travel than embodiments with 6 or more ground engaging means.

Embodiments of the suspension arrangement 18 can include upper and lower suspension links associated with the suspension for at least one of the ground engaging means, preferably for each of the provided ground engaging means. For example, the ground engaging means 16 or each ground engaging means 16 (e.g. 16a, 16b, 16c, 16d) can have up and down suspension arrangement 18 travel (see up-down arrows shown in FIGS. 1B, 1C, 2B and 2C) by connection to the support platform via a respective upper suspension link arrangement 26 and a respective lower suspension link arrangement 28.

An upper suspension link arrangement 26 or a lower suspension link arrangement 28, or both, can include respective upper inner 30ui and upper outer 32uo suspension arms or links and/or lower inner 30 li and lower outer 30lo suspension link arms.

Pairs of upper and lower suspension link arrangements can be provided in embodiments for up and down parallel motion of the respective pivot hub 22 whilst maintaining the correct ground engaging means orientation relative to the ground and for steering accuracy and mobile platform/vehicle stability.

The respective pivot hub 22 enables rotation of the associate ground engaging means 16 about a vertical axis for steering/direction control of the mobile platform/vehicle 10. The respective pivot hub 22 can include drive means 34 (such as one or more steering actuators) to power rotation about the respective upright/vertical pivot axis. Drive to the respective ground engaging means 16 can be provided by ground engaging drive means 24 (e.g. 24a, 24b, 24c, 24d), which can be hydraulically powered, electrically powered or pneumatically powered. The ground engaging drive means 24 can provide a wheel assembly having a drive motor and a gearbox.

One or more suspension accumulators 21 can be provided, such as to store and return energy from suspension movements to help absorb impacts from, and smooth travel over, rough terrain. An electric motor 23 can be provided, such as to power one or more components or systems of the vehicle/platform 10. For example, one or more electric motors (e.g. electric motor 23) can be provided to power one or more hydraulic pumps, such as for powering the ground engaging means, the steering and/or the suspension.

Payload can be selectively dispensed through at least one dispensing outlet 36 provided underneath the support structure/chassis 12. For example, in embodiments transporting and dispensing explosive, such as ANFO, controlled dispensing of the explosive can be through the at least one dispensing outlet 36. It will be appreciated that the mobile platform/vehicle 10 can straddle a drill/blast hole to dispense the explosive (or other payload-such as lowering a sensing instrument into the drill/blast hole).

Coarse positioning of the mobile platform or vehicle 10 can be autonomous, semi-autonomous or guided, such as by an operator having tele-remote control connection to the mobile platform or vehicle, such that the operator is able to remain at a safe distance during transport and/or dispensing of the payload. A preferable safe distance when transporting explosive on the mine site is 5-10 m. The safe distance when dispensing is for an operator to be away from the blasting pattern/plan.

Coarse positioning can include the mobile platform/vehicle travelling over the contoured terrain, negotiating any obstacles, holes, rocks, slopes and gradients by operation of the suspension whilst maintaining the load level as desired. Fine positioning can be provided by the ability of the mobile platform/vehicle to rotate the ground engaging means about the vertical pivot axes such that the payload can be moved forwards-backwards, sideways (left-right) at 90° to forward-backward, or any angle between forward-backward and 90° sideways.

The rotation of the ground engaging means about the respective vertical axes enables diagonal ‘crabbing’ motion to enhance fine positioning or coarse steering, and accurate ‘over the hole’ positioning.

Once positioned over the blast/drill hole to release payload into the blast/drill hole, the mobile platform or vehicle can ensure that the load is level even on contoured ground, such as a gradient or cross-slope, by adjusting the height of each suspension arrangement as required in relation to the ground height under each ground engaging means. Payload is dispensed correctly (e.g. directly downward) even while the ground is sloping or uneven.

Embodiments include load sensing, such as payload weight/mass in a container or hopper 14 (or other reservoir). One or more load cells 38 may be provided to detect change in load (payload added or payload dispensed). One or more load cells may be provided to sense payload distribution.

Power systems or parts thereof, such as a hydraulic system, hydraulic pump(s) 25 etc., can be provided in a compartment 40 on/in the payload support structure/chassis 12. In the case of hydraulic suspension, the suspension arrangement can include one or more suspension accumulators 41 to store/absorb/return hydraulic pressure.

Electric power can be provided by one or more on-board batteries which may be retained in a battery compartment 44 preferably with a fire/heat shield 42 separating the batteries form the container and payload.

Electric control systems, such as for guidance, GPS, sensing and power control can be provided in one or more control compartments/boxes 46.

Fire suppression can be provided by a fire suppression system 50. Lights 52, such as operation mode lights, can be provided. Mode lights can indicate one or more operational or functional conditions of the vehicle/platform, such as flashing lights for warnings. Light colour can be controlled to indicate certain operational conditions, such as autonomous or remote control. Such operation mode lights can be operated to indicate what is controlling the vehicle eg steady or flashing pattern and/or indicating by colour, such as blue for autonomous/remote teleoperation control, green for line-of-sight remote control, red for emergency stop having been activated.

The payload container/hopper 14 may include a removable cover 54, such as at least one retractable/deployable cover, which may include at least one flexible fabric/material cover, such as a tarpaulin, which may be deployed by a roller arrangement.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. Apparatus includes a mobile platform for transporting and/or delivering a payload across contoured terrain to a drilled hole or blast hole, the mobile platform including a payload support structure, a plurality of ground engaging means for traversing the contoured terrain, and a suspension arrangement supporting the payload support structure on the plurality of ground engaging means.

2. The apparatus of claim 1, wherein the suspension arrangement includes height adjustable independent suspension for each ground engaging means that enables the respective ground engaging means to follow rising or falling ground level contours whilst adjusting payload support structure height to maintain an attitude, preferably a level attitude, of the payload substantially level.

3. The apparatus of claim 1, wherein at least two of the ground engaging means are steerable between around +90° and around −90° relative to a forward-rearward 0° axis of the mobile platform.

4. The apparatus of claim 3, wherein all of the ground engaging means are steerable between the +90° and −90°, providing around 180° steering and direction control enabling up to 90° direct sideways movement or diagonal crabbing movement of the mobile platform.

5. The apparatus of claim 1, wherein the ground engaging means includes a plurality of wheels.

6. The apparatus of claim 5, wherein each of the wheels has dedicated power drive.

7. The apparatus of claim 6, wherein power drive to each respective wheel is provided by hydraulic, pneumatic or electric drive.

8. The apparatus of claim 7, wherein at least one, preferably all, of the power drives drive a respective axle of a respective wheel directly or through a gearbox drive.

9. The apparatus of claim 1, wherein the suspension arrangement includes at least one actuator providing up-down height adjustment of the payload support structure relative to the ground engaging means.

10. The apparatus of claim 9, wherein the at least one actuator includes at least one hydraulic, pneumatic or electric actuator, or a combination of any two or more thereof.

11. The apparatus of claim 9, wherein the mobile platform includes a hydraulic system providing hydraulic pressure and at least one hydraulic pressure sensor, wherein the up-down height adjustment is provided by at least one hydraulic cylinder or ram of the suspension system extending or retracting under control of sensed pressure for the respective hydraulic cylinder or ram associated with a respective ground engaging means to maintain an attitude of the payload support structure.

12. The apparatus of claim 9, including at least one respective said pressure sensor and/or at least one respective said linear transducer configured to detect and/or influence suspension adjustment for change in ground contour(s) as the vehicle/mobile platform traverses the terrain.

13. The apparatus of claim 1, wherein the mobile platform includes: a control system having a control unit, at least one sensor system and at least one sensor for sensing at least one of: features of the terrain, geo-fenced boundary, blast/drilled hole location.

14. The apparatus of claim 13, wherein the at least one sensor system includes one or more of lidar, radar, infra-red, camera, inclination/incline sensor, GPS.

15. The apparatus of claim 13, wherein the control system and the at least one sensor system are configured to identify gradients, inclination of gradients, drop-offs and/or obstacles beyond predefined operating parameters of the mobile platform and prevent the vehicle from progressing into such conditions.

16. The apparatus of claim 13, said pressure sensors are located in the hydraulic system near the hydraulic actuators, the gyroscope and accelerometer are located in the control unit, the linear transducers are respectively located on, in or adjacent the hydraulic actuators.

17. The apparatus of claim 13, wherein the at least one sensor is arranged and configured to transmit signals/data to the control unit which interprets the received signals/data, and wherein the control unit sends control commands back to the hydraulic system.

18. The apparatus of claim 13, wherein the control system is configured to predict at least one upcoming gradient, inclination and/or hazard based on current gradient, inclination and/or hazard data and/or past gradient, inclination and/or hazard data.

19. The apparatus of claim 13, wherein the control system includes control of the suspension system and/r steering of the vehicle or mobile platform based providing feedback to the at least one pressure sensor and/or the at least one linear transducer.

20. The apparatus of claim 13, wherein the control system is configured to control the suspension system to actively drive the respective ground engaging means upward to accommodate a rise in the terrain contour.

21. The apparatus of claim 19; wherein the control system is configured to control the suspension system to actively drive the respective ground engaging means downward to accommodate a dip in terrain contour or to control descent of the respective ground engaging means.

22. The apparatus of claim 13, wherein the control system is configured to compare computed/calculated gradient, inclination and/or hazard against one or more pre-defined parameters.

23. The apparatus of claim 22, wherein, when the computed/calculated gradient, inclination, and/or hazard data is within the at least one parameter, the control system is configured to instruct the vehicle to proceed.

24. The apparatus of claim 22, wherein, if the computed/calculated gradient, inclination, and/or hazard data outside the at least one parameter, the vehicle/mobile platform is directed by the control system to take an alternative route or is directed to stop.

25. The apparatus of claim 13, including at least one load sensor for sensing a payload supported by the payload support structure.

26. The apparatus of claim 25, wherein the at least one load sensor includes at least one load cell arranged and configured to sense a payload weight or mass present within the payload container or hopper to assess how much material/payload has been loaded into or unloaded from the container/hopper.

27. The apparatus of claim 1, wherein the payload support structure includes a container or hopper for holding explosive or stemming.

28. The apparatus of claim 27, wherein the mobile platform includes at least one outlet with an opening to underneath the container or hopper for dispensing the explosive or stemming into the drilled/blast hole while the mobile platform straddles the drilled/blast hole.

29. The apparatus of claim 1, including at least one load sensor for sensing a payload supported by the payload support structure.

30. The apparatus of claim 29, wherein the at least one load sensor includes at least one load cell arranged and configured to sense a payload weight or mass present within the payload container or hopper.

31. The apparatus of claim 1, wherein the suspension arrangement provides up-down articulation range between 1.0 m and 1.5 m, preferably 1.1m to 1.3 m, and more preferably around 1.2 m, between maximum height up and minimum height down.

32. The apparatus of claim 1, wherein the suspension arrangement includes upper and lower suspension links associated with the suspension for at least one of the ground engaging means, preferably for each of the provided ground engaging means.

33. The apparatus of claim 1, including connection of the ground engaging means to the support structure via a respective upper suspension link arrangement and a respective lower suspension link arrangement.

34. The apparatus of claim 33, wherein the upper suspension link arrangement or the lower suspension link arrangement, or both, include respective upper inner and upper outer suspension arms or links and/or lower inner and lower outer suspension arms or links.

35. The apparatus of claim 33, wherein pairs of upper and lower suspension link arrangements are provided for up and down parallel motion of a respective pivot hub whilst maintaining correct ground engaging means orientation relative to the ground and for steering accuracy.

36. The apparatus of claim 35, wherein the respective pivot hub enables rotation of the associate ground engaging means about a vertical axis for steering/direction control of the mobile platform.

37. The apparatus of claim 36, wherein the respective pivot hub includes drive means to power rotation of the respective ground engaging means about the respective upright/vertical pivot axis.
